(19) United States
(12) Patent Application Publication
(10) Pub. No.: US 2025/0042119 A1
(43) Pub. Date: Feb. 6, 2025

(54) STAMPING GEAR, SEALING GEAR, PAIR OF EMBOSSING GEARS AND APPARATUS FOR FORMING A WEB MATERIAL INTO A CUSHIONING PRODUCT

(71) Applicant: Sprick GmbH Bielefelder Papier- und Wellpappenwerke & Co., Bielefeld (DE)

(72) Inventors: Bastian Schalk, Detmold (DE); Erik Albert, Horn-Bad Meinberg (DE)

(73) Assignee: Sprick GmbH Bielefelder Papier- und Wellpappenwerke & Co., Bielefeld (DE)

(21) Appl. No.: 18/695,974

(22) PCT Filed: Sep. 28, 2022
(86) PCT No.: PCT/EP2022/077003

§ 371 Date: Mar. 27, 2024

(30) Foreign Application Priority Data
Sep. 28, 2021 (DE) 10 2021 125 078.1
Sep. 28, 2021 (DE) 10 2021 125 089.7

(51) Int. Cl. B31D 5/00

(52) U.S. Cl. CPC B31D 5/0047; B31D 2205/0023; B31D 2205/0064

(57) ABSTRACT

An apparatus for processing a web material may include a stamping for a pair of embossing gears for forming a web material. The web material may include a paper web, and the material may be formed into a cushioning product. The stamping gear may have a plurality of embossing teeth, valleys arranged between adjacent embossing teeth, and punching nose arranged in the region of the valleys. The stamping gear may have embossing teeth which are continuous in the axial direction.

### CROSS REFERENCE TO RELATED APPLICATIONS

This patent application is a U.S. national stage application of International Application No. PCT/EP2022/077003, filed Sep. 28, 2022, which claims priority to German Patent Application No. 102021125078.1, filed Sep. 28, 2021, and German Patent Application No. 102021125089.7, filed Sep. 28, 2021, each of which is incorporated herein by reference in its entirety.

### BACKGROUND

### Field

The disclosure relates to a stamping gear and a sealing gear for a pair of embossing gears of an apparatus for forming a web material, in particular a paper web, into a cushioning product. The disclosure also relates to a pair of embossing gears for an apparatus for forming a web material into a cushioning product. Furthermore, the disclosure relates to an apparatus for forming a web material into a cushioning product. The web material may be in the form of a starting material web roll, in particular in the form of a preferably coreless roll, or a leporello-stack.

### Related Art

WO 2000 020 196 A2 describes a cushioning conversion machine with an embroidery arrangement. Embroidery means are included therein which include a plurality of radially outwardly directed projections which mesh with one another. One of the embroidering means includes a receptacle and the other embroidering means includes cutting edges which penetrate the recesses to introduce rows of slits into a sheet material to interlock overlapping sections of the sheet material. The embroidery means are pressed against each other.

WO 2018 005 902 A1 describes another cushion conversion arrangement. The cushion conversion arrangement includes a pair of gears having a plurality of teeth rotatable about a respective axis. The teeth of one gear wheel mesh with the teeth of the other gear wheel. Both gear wheels are provided with wedge-shaped outer segments and a center segment with shorter, narrower teeth that are offset in the direction of rotation relative to the teeth of the outer segments and capped on the outside periphery with a sharp edge. The center segments create a series of parallel slots in a sheet material guided by the pair of gears so that frictional forces along the slot edges hold the layers of sheet material together.

With known cushioning conversion devices, the sheet material often tears at the embroidery means or gear wheels, which can lead to reduced cushioning quality or paper jams. Another problem is that layers of sheet material may be insufficiently connected together, which also affects cushioning material quality. The cushioning conversion machines also generate a high level of noise, which is perceived as annoying.

The paper web can be single- or multi-layered. The material of the paper web can be, for example, craft paper or recycled paper, in particular from recycled waste paper, cardboard or board. The use of recycled paper is preferred due to its particular environmental friendliness. The paper web can be provided as a supply, for example, as a wound roll, in particular as a coreless roll, or leporello-stack. The longitudinal extension of the paper web is preferably essential, i.e. at least 10, 50 or 100 times greater than the width of the paper web. The thickness of the paper web corresponds to the thickness of the single- or multi-layered paper material and is preferably less than one millimeter.

The material of the paper web is made in particular from recycled paper. Recycled paper is in particular paper materials with a low proportion (less than 50%) of fresh fiber-containing paper material. In particular, paper materials containing 70% to 100% waste paper are preferred. The recycled paper can preferably be paper material that can have a tensile strength index along the web direction of at most 90 Nm/g, preferably a tensile strength of 15 Nm/g to 60 Nm/g and a tensile strength index transversely to the web direction of at most 60 Nm/g, preferably a tensile strength of 5 Nm/g to 40 Nm/g. A DIN EN ISO 1924-2 or DIN EN ISO 1924-3 standard can be used to determine the tensile strength or tensile strength index. Additionally, or alternatively, a recycled paper property or waste paper property can be characterized by the so-called burs resistance. A material in this sense is recycled paper with a burst index of at most 3.0 kPa*m\hat{ }2/g, preferably with a burst index of 0.8 kPa*m\hat{ }2/g to 2.5 kPa*m\hat{ }2/g. The DIN EN ISO 2758 standard is used to determine the burst index. Furthermore, the material of the paper web has a basis weight of in particular 40 g/m\hat{ }2 to max. 140 g/m\hat{ }2. According to the disclosure, the starting material of the paper web can be in the form of a material web roll or a zigzag-folded packaging material stack, also known as a leporello-stack.

DE 690 30 410 T2 describes a fill material product for use as a packaging or wrapping material formed with lateral, pillow-like sections and a central connecting section running lengthwise of the product. The product is formed from a three-layered web of stock material, typically provided in a 76.2 cm [30 inch] wide roll. The edges of a stock material are rolled inward to form pillow-like sections joined along their contacting abutting sides by embossed sections. Perforations are also provided in the connecting section by which unraveling or separating of the connecting section is to be prevented. The cushioning product is 20 to 23 cm [8 to 9 inches] wide, wherein the central section is at least 3.8 cm [1½ inches] wide and about 1.3 to 1.9 cm [½ to ¾ inches] high. The pillow-like sections are about 5.1 to 6.4 cm [2 to 2½ inches] wide.

GB 2501260 A also describes a cushioning material product. According to this, a web of paper material with multiple rolled-up side edges is drawn in under tensile stress by indenting gear wheels in order to be partially indented by them. In the cushioning material product thus produced, the rolled-up side edges of the paper material web are included in the indented portion. In this way, a stable cushioning material product is to be produced, which is to have a sufficient volume with the lowest possible longitudinal shrinkage compared to the starting paper material web.

DE 10 2012 018 941 A1 discloses a packaging product formed from a paper web material in which longitudinal edge strips have been turned-over and a sequence of embossing valleys and embossing mountains has been introduced into a central region of the web. The turned-over longitudinal edge strips form cavity pads on both sides of the central area, which extend in the longitudinal direction. Slit perforations are provided on the short sides of the packaging product, forming slit edges that interlock with each other under different paper web section layers. The center area remains free of perforations to avoid damaging the paper web layers and thereby weakening the packaging product. Such a packaging product is about 30 cm long and 16 cm wide. The packaging product formed in this way is in particular dimensionally stable, in particular in the region of the lateral crumpled cavities, which primarily provide the elastic restoring forces of the packaging product.

Conventional packaging products or cushioning material products have proven to be unsuitable for small packages. To achieve the desired cushioning stability, conventional products require minimum dimensions that are too large for small packages. When the products manufactured in the known way are reduced below the minimum dimensions of a width of about 16 cm and a length of about 30 cm, it has been found that the intended cushioning properties are lost.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 a side sectional view of a forming apparatus according to the disclosure;

FIG. 2 a sectional view of a forming apparatus according to the disclosure, viewed from above;

FIG. 3 a side view of a pair of embossing gears according to the disclosure;

FIG. 4 a detailed view of the regions of the pair of embossing gears meshing into one another as shown in FIG. 3;

FIG. 5 a front view of the pair of embossing gears according to FIG. 3;

FIG. 6 a side view of an edge segment for a sealing- or stamping gear according to the disclosure;

FIG. 7 a side view of a center segment for a sealing- or stamping gear according to the disclosure;

FIG. 8 a side view of a punching segment for a stamping gear according to the disclosure;

FIG. 9 a side view of a sealing segment for a sealing gear according to the disclosure;

FIG. 10 a perspective view of a stamping gear according to the disclosure on a frame with a spring device;

FIG. 11 a perspective view of a sealing gear according to the disclosure;

FIG. 12 a schematic representation of a cushioning product;

FIG. 13 a cushioning piece according to the disclosure;

FIG. 14 a schematic representation of a cushioning material forming apparatus according to the disclosure;

FIG. 15 a schematic representation of the cushioning material forming apparatus according to the disclosure as shown in FIG. 14;

FIG. 16 a schematic sectional view through a strand of cushioning material or cushioning piece according to the disclosure;

FIG. 17 a top view of a cushioning piece;

FIG. 17a top view of a rolled-up and unfolded cushioning piece made from a single layer-starting-paper web;

FIG. 18 a schematic measurement setup for determining cushion properties;

FIG. 19 an embodiment of a cushioning material forming apparatus; and

FIG. 20 another view of the cushioning material forming apparatus shown in FIG. 19.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the disclosure is to overcome the problems of the prior art, in particular to provide gears, a gear pair or a cushioning conversion apparatus, with which a continuously high cushioning material quality is ensured, wherein the cushioning material quality is preferably improved in comparison to conventional apparatuses and/or which provide a reduced susceptibility to paper jams and/or in which the noise emission is reduced in comparison with conventional apparatuses, and/or to provide a particularly compact cushioning material, such as a cushioning strand or a cushioning piece, as well as a cushioning material forming apparatus, wherein a high cushioning effect is ensured and wherein in particular the cushioning material is not too soft and/or not too hard.

Accordingly, a stamping gear is provided for a pair of embossing gears of an apparatus for forming a web material, in particular a paper web, into a cushioning product. The web material may be in the form of a starting material web roll, in particular in the form of a preferably coreless roll, or a leporello-stack. The stamping gear has a plurality of embossing teeth, valleys arranged between adjacent embossing teeth, and punching noses arranged in the region of the valleys. Preferably, at least one punching nose is arranged in the region of each valleys. Alternatively, valleys in the circumferential direction of the embossing gear can be successively alternatingly punching nose-free and equipped with at least one punching nose. According to the disclosure, the stamping gear may have embossing teeth which are continuous in the axial direction. The axial direction of the stamping gear corresponds to the operational axis of rotation of the stamping gear. Along the outer circumference of the stamping gear, embossing teeth and valleys alternate. With respect to the axis of rotation of the stamping gear, the sections of the stamping gear forming the embossing teeth have a larger outer radius than the sections of the stamping gear forming the valleys. In particular, at least one punching nose is arranged in several of the plurality of valleys, preferably in all of them. With respect to the axis of rotation of the stamping gear, the punching noses have a punching nose outer radius which is smaller than the outer radius of the embossing teeth and which is larger than the outer radius of the valleys. By providing embossing teeth which are continuous in the axial direction in the stamping gear according to the disclosure, the risk of tearing of the web material to be formed in the region of the stamping gear is reduced to a considerable extent compared to a conventional pair of embossing gears. This can increase the quality of the cushioning product to be formed and reduce the risk of material jams.

In an exemplary embodiment of the stamping gear, it is provided that the stamping gear, in particular edge segments of the stamping gear, has axial outer side surfaces, wherein transition regions, such as at least one phase or at least one radius, are provided between the outer side surface and the embossing teeth. The plurality of edge segments of the stamping gear may have the same dimensions. In particular, the transition regions may be rounded. In the region of the valleys, transition regions to the outer side surface can optionally be provided. With the aid of transition regions between the outer side surfaces of the stamping gear and its embossing teeth, the risk of tearing of the web material to be formed can also be reduced, and thus the cushioning product quality can be increased and the risk of material jams reduced. Surprisingly, it has also been shown that stamping gears with transition regions can be operated with comparatively low noise levels.

According to another embodiment, the stamping gear includes a plurality of disc-shaped axial segments. The axial segments comprise two edge segments having a plurality of uniform embossing teeth and valleys formed between adjacent embossing teeth. Further, the axial segments comprise at least one stamping segment arranged axially between the edge segments and having punching noses arranged in the region of the valleys. Preferably, the stamping segment has a plurality of tooth sections corresponding to the embossing teeth. Preferably, the stamping gear is shaped congruently with the embossing teeth of the edge segments in the region of the tooth sections. The stamping gear can be formed from several disc-shaped axial segments. Disc-shaped axial segments are easy to manufacture in the same shape, which makes assembly easier and facilitates smooth running in operation, which increases cushioning product quality and reduces noise emissions. The tooth sections of the stamping segment preferably have the same cross-sectional shape as the embossing teeth of the edge segments.

According to a further development, the stamping gear comprises two stamping segments arranged between the edge segments and at least one center segment arranged between these stamping segments. It may be preferred that two, three or more center segments are provided between the edge segments. Several, in particular all center segments of a stamping gear may be of the same dimensions. It may be preferred that a plurality of center segments of a stamping gear have a single center segment that has a different axial width than the other center segments of the same type. In particular, the multiple stamping segments are of the same dimensions. Preferably, the center segment is shaped corresponding to the edge segments. Alternatively, it may be provided that the center segment is shaped differently from the edge segments. For example, a center segment may be embodied as a gear wheel with helical teeth or double helical teeth. Optionally, the center segment may be formed as a pair or a group of gear wheels with helical teeth, in particular with co-rotating or counter-rotating teeth. The cross-sectional shape of the center segments and the edge segments is preferably the same, in particular congruent.

The disclosure also relates to a sealing gear for a pair of embossing gears of an apparatus for forming a web material, in particular a paper web, for example in the form of a preferably coreless roll or a leporello-stack, into a cushioning product. The axial direction of the sealing gear corresponds to the operational axis of rotation of the sealing gear. The sealing gear has a plurality of disc-shaped axial segments, comprising two edge segments with a plurality of uniform embossing teeth and valleys formed between adjacent embossing teeth, and at least one sealing segment arranged axially between the edge segments and having a rotationally symmetrical shape with respect to the gear axis and/or a maximum sealing segment radial extension which is not larger than, in particular as large as, the preferably smallest edge segment radial extension in the region of the valleys. According to the disclosure, it is provided that the sealing gear, in particular the edge segments of the sealing gear, have axial outer side surfaces, wherein, in particular, rounded transition regions are provided between the outer side surface and the embossing teeth. In particular, the sealing gear, in particular edge segments of the sealing gear, has axial outer side surfaces, wherein transition regions, such as at least one phase or at least one radius, are provided between the outer side surface and the embossing teeth and/or the valleys. Optionally, transition regions to the outer side surface may be provided in the region of the valleys. Preferably, the sealing gear is free of punching noses.

The disclosure also relates to a pair of embossing gears for an apparatus for forming a web material, in particular a paper web, for example in the form of a preferably coreless roll or a leporello-stack, into a cushioning product. The pair of embossing gears comprises a stamping gear with embossing teeth, valleys arranged between adjacent embossing teeth and punching noses arranged in the region of the valleys, as well as a sealing gear which can be brought into or is in engagement with the stamping gear. In particular, the stamping gear is embodied as described above. In particular, the sealing gear is embodied as described above. It may be preferred that the embossing teeth and valleys of the stamping gear and the embossing teeth and valleys of the sealing gear are shape-matched to each other. It may be particularly preferred that the edge segments of the stamping gear and the edge segments of the sealing gear are of the same dimensions. Alternatively, the edge segments of the sealing gear and/or the stamping gear may have different widths. Preferably, edge segments of a sealing gear and a stamping gear can be interchangeable.

According to the disclosure, a radial distance with a distance width in the range 0.01 mm to 1 mm is formed between the sealing gear and the stamping gear. In particular, the radial distance has a distance width in the range of 0.05 mm to 0.5 mm. It may be particularly preferred that the distance width is in the range 0, 1 mm to 0.2 mm. It should be understood that preferably the radial distance between the gear wheels of the pair of embossing gears, in the operational position of the gear wheels, free of any occupancy of the pair of embossing gears by the web material, in particular paper web, and free of any occupancy by cushioning material, has the distance width. Preferably, the stamping gear and the sealing gear can be mounted on a frame of the forming apparatus in such a way that the sealing gear meshes with the stamping gear, wherein preferably the respective outer circumference of the stamping gear and of the sealing gear are matched to one another in such a way that radial adaption of the stamping gear against the sealing gear is prevented. In particular, the stamping gear and the sealing gear are held on the frame of the forming apparatus and their outer circumferences are matched to each other in such a way that there is substantially pure tangential contact between the sealing gear and the stamping gear. The stamping gear and the sealing gear are preferably mounted and matched to one another in such a way that the tooth flanks of the embossing teeth grip one another, in particular roll against one another, without the tooth heads coming into contact with the tooth base or valley base. The radial distance is preferably always provided between the valley base of the sealing gear and the tooth head of the stamping gear engaging therein and/or between the valley base of the stamping gear and the tooth head of the sealing gear engaging therein. A tangential contact between the stamping gear and the sealing gear can be provided if, for example, only one of the gears, cither stamping gear or sealing gear, is directly driven by a motor and drives the other of the gears. Contrary to the existing prejudice that the gear wheels of a pair of embossing gears must necessarily exert a radial pressure against each other in order to ensure sufficient cushioning quality, it has been shown that the provision of a radial distance can not only significantly reduce the operating noise of a forming apparatus with a pair of embossing gears according to the disclosure, but can also provide a cushioning product of particularly good cushioning quality.

According to an exemplary embodiment of a pair of embossing gears, the sealing gear comprises a plurality of disc-shaped axial segments, wherein the axial segments comprise two edge segments having a plurality of uniform embossing teeth and valleys formed between adjacent embossing teeth, and at least one sealing segment arranged axially between the edge segments and having a rotationally symmetrical shape with respect to the gear axis and/or a maximum sealing segment radial extension which is not larger than, in particular as large as, the preferably smallest edge segment radial extension in the region of the valleys.

In an exemplary embodiment, the pair of embossing gears with a segmented sealing gear, the latter may include a sealing segment axial extension which is at least as large as an axial width of the punching noses and/or as large as a stamping segment axial extension of the stamping segment. In particular, the sealing segment axial extension may be least 0.1 mm, in particular at least 0.2 mm, larger than the axial width. Alternatively, or additionally, it may be provided that the sealing segment axial extension is not more than 0.5 mm, in particular not more than 0.3 mm, larger than the axial width. Particularly preferably, the stamping gear is matched to the sealing gear in such a way that punching noses on the circumference of the stamping gear engage in and/or roll in corresponding openings on the circumference of the sealing gear, in particular in the region of the embossing teeth of the sealing gear. Preferably, for example, the stamping gear is matched to the sealing gear in such a way that about 0,125 mm clearance is provided on both sides of the embossing teeth. Viewed in the axial direction, the sealing gear and the stamping gear are preferably matched to one another in such a way that the punching noses penetrate into axial openings along the sealing gear/stamping gear pair heads, so that when the stamping gear rolls on the sealing gear, stamping perforations are introduced into the cushioning product to be formed.

A further development of the pair of embossing gears, which can be combined with the previous one, provides that the segmented sealing gear comprises at least two sealing segments arranged between the edge segments and at least one center segment arranged between the sealing segments. It may be preferred that two, three or more center segments are provided between the edge segments. Several, in particular all, center segments of a sealing gear may have the same dimensions. Several, in particular all, center segments of the sealing gear and the stamping gear may be of the same dimensions. It may be preferred that a plurality of center segments of a sealing gear have a single center segment that has a different axial width than the other center segments of the same type. In an exemplary embodiment, the plurality of sealing segments are of the same dimensions. In an exemplary embodiment, the center segment is shaped corresponding to the edge segments. The cross-sectional shape of the center segments and the edge segments is preferably the same, in particular congruent. An exemplary embodiment of the pair of embossing gears provides that the stamping gear and the sealing gear have equally dimensioned edge segments and/or center segments.

In one embodiment of a pair of embossing gears, the stamping gear as well as the sealing gear each have a pair of axial outer side surfaces opposite one another in the axial direction. Transition regions, such as at least one phase or at least one radius, are provided between the outer side surfaces and embossing teeth of the stamping gear and/or the sealing gear. Preferably, the transition regions are rounded.

In an exemplary embodiment, the sealing gear is free of punching noses. In conventional stamping gears, punching noses are usually provided on both gears of a pair of embossing gears meshing into one another. However, it has been found that for forming the web material into a continuously high quality cushioning product, punching noses are preferably provided on only one gear wheel, the stamping gear, of the pair of embossing gears. In this way, a continuously uniform punching of the web material can be realized, wherein in particular collisions between opposing punching noses are avoided, which would contribute both to excessive noise generation and to tearing of the web material.

In an alternative embodiment, a pair of embossing gears is provided in which the sealing gear is realized as a second embossing gear with punching noses, wherein the first embossing gear and the second embossing gear are matched to each other in such a way that the punching noses of the first embossing gear engage in punching-nose-free embossing-valley axial regions of the second embossing gear, and vice versa. For example, the first and second embossing gears can be provided with two or more axial regions offset in the axial direction, in which the first and second embossing gears, each in the circumferential direction of the embossing gear, are each successively alternatingly punching nose-free and equipped with at least one punching nosc.

In one further development of the alternative embodiment of the pair of embossing gears, the first embossing gear and the second embossing gear are matched to one another in such a way that the punching noses of the first embossing gear engage in punching-nose-free embossing valleys of the second embossing gear, and vice versa. In particular, the first and second embossing gears, each in the circumferential direction of the embossing gear, have successively alternating punching nose-free valleys and valleys equipped with at least one punching nose.

Furthermore, the disclosure relates to an apparatus for forming a web material, in particular a paper web, for example paper web in the form of a preferably coreless roll or a leporello-stack, into a cushioning product with at least one stamping gear, in particular as described above, at least one sealing gear, in particular as described above, and/or at least one pair of embossing gears, in particular as described above.

In an exemplary embodiment of a forming apparatus according to the disclosure, one of the gear wheels of the pair of embossing gears, in particular the stamping gear, is held biased on a frame of the apparatus transversely to the axial direction of the gear wheel with a spring device. In particular, the spring device provides a spring constant of at least 5 N/mm, at least 10 N/mm or at least 15 N/mm, in particular at least 30 N/mm. Alternatively or additionally, the spring device may be configured to provide a biasing force of at least 200 N, in particular at least 350 N, preferably at least 600 N. It should be understood that the biasing force is provided in the radial direction with respect to the axis of rotation. Preferably, the biasing force is provided for a pair of embossing gears according to the disclosure in which the radial distance is between the stamping gear and the sealing gear. Thereby, the frame may comprise a counter bearing for the axis and/or shaft for bearing the biased gear wheel, in particular the stamping gear, wherein the counter bearing holds the gear wheel, in particular the stamping gear, at the radial distance with respect to the other gear wheel, in particular the sealing gear, preferably when the space between the gear wheels of the pair of embossing gear wheels is free of the web material, in particular the paper web, as well as free of the cushioning product. The forming apparatus is thus formed in such a way that the biasing force does not act directly from one gear wheel to the other gear wheel of the pair of embossing gears. In particular, the biasing force is activated only when web material is converted into cushioning product between the gear wheels of the pair of embossing gears, wherein the web material and/or the cushioning product occupies the radial distance between the gear wheels.

In particular, an embodiment of a forming apparatus comprises a preforming device adapted and arranged for introducing turned-over and/or rolled-up cushioning regions along opposite longitudinal marginal edges of the web material, wherein the stamping gear and/or the pair of embossing gears has a gear axial width for gripping both cushioning regions. In particular, the preforming device has a guiding device, such as converging guide rods, the dispensing distance of which being substantially equal to the gear axial width. Alternatively, the dispensing distance may be greater than the gear axial width.

Preferably, the forming apparatus is adapted and arranged to dispense a cushioning product with a piece length of not more than 30 cm or not more than 25 cm, in particular not more than 15 cm, preferably not more than 10 cm or not more than 5 cm, particularly preferably not more than 3 cm. Alternatively or additionally, the forming apparatus is adapted and arranged to output a cushioning product having a piece width of at least 4 cm or 5 cm, in particular at least 8 cm, preferably at least 10 cm, and/or not more than 12 cm, in particular not more than 10 cm. Particularly preferably, the cushioning width can be in a range of 7 cm to 10 cm, more preferably in the range of 8 cm to 9 cm.

In another embodiment, the sealing gear is configured as a one-piece gear wheel. The edge and center segments described in more detail above, as well as a sealing segment, are manufactured in one piece. The at least one sealing segment is formed from a radially circumferential groove which corresponds with the respective stamping segment. The groove interrupts the embossing teeth of the sealing gear. The groove is approximately 0.1 mm to 0.2 mm wider than the width of the corresponding punching noses of the stamping gear, which can thus enter the grooves with clearance. Furthermore, the outer diameter of the groove is smaller than the tooth base diameter of the sealing gear. This embodiment has also proved advantageous, wherein manufacturing tolerances now play a smaller role and assembly of the forming apparatus is simplified.

Furthermore, it is irrelevant to the disclosure which of the pair of embossing gears is connected to the electric drive motor. In an exemplary embodiment, the sealing gear is fixedly connected to the output shaft of a gear driven by the electric drive motor. In this case, the gear, as well as the gear output shaft and also its bearing, are arranged in such a way that the gear output shaft together with the bearing absorbs not only the drive torque but also all other forces that occur during operation of the forming apparatus. In this way, the forming apparatus is particularly compact and easy to install.

As the sealing gear is connected to the gear and is configured as a driving gear, the stamping gear runs loosely with the sealing gear due to the tooth engagement. The stamping gear is mounted in a floating manner along its central longitudinal axis.

The punching noses of the stamping segment, which depending on the embodiment of the sealing gear either run in the radially circumferential groove of the sealing gear or are aligned congruently with the sealing segment and run in a groove which clamps the sealing segment between an edge segment and a further segment, thus guide the stamping gear within this floating bearing. Manufacturing and assembly tolerances are compensated by this floating bearing. The movable path distance of the floating bearing is in the range of 2 mm, i.e. in the range of +/−1 mm referred to the mean nominal position. Various machine elements such as adjusting rings or retaining rings or the like, but also recesses or shoulders of the shaft or axle can serve as limiting means for the path distance.

According to another embodiment, the stamping gear is fixed to the gear output shaft and the sealing gear is floatingly mounted along its central longitudinal axis.

In extension of the description of the floating bearing mentioned at the beginning, an axle is preferably provided on which, depending on the embodiment, the stamping gear or the sealing gear is rotatably mounted. Alternatively, a shaft can be provided which, depending on the embodiment, is connected to the stamping gear or to the sealing gear and is floatingly mounted together therewith in bearings.

Furthermore, another embodiment of a stamping gear with only one stamping segment should be mentioned, wherein the stamping segment or the punching noses are arranged substantially in the center of the side edges of the stamping gear. In such an embodiment, a one-piece stamping gear is provided, wherein all segments mentioned at the beginning, but at least the embossing teeth and the punching noses, consist of a one-piece molded part. The stamping gear can thus be formed as a die casting, an investment casting, a sintered part, a precision forging, or the like. In this embodiment, each embossing teeth of the stamping gear is then formed as a continuous embossing tooth in the axial direction.

In contrast to this, in the aforementioned designs of the stamping gears, which are composed of several segments, the respective embossing teeth of the at least one edge segment and of the center segment and of the stamping segment are congruent and without gaps in the axial direction, so that thereby the respective continuous embossing tooth is formed from one side to the other side of the stamping gear.

In addition to the embodiments, one embodiment provides for one of the two embossing wheels to be removed or swung away. This can be very helpful for maintenance purposes or for clearing paper jams. For this purpose, the floatingly mounted embossing wheel of the pair of embossing wheels is designed to be removable. However, it is a particularly user-friendly feature to pivot away the floatingly mounted embossing wheel, wherein this embossing wheel together with the bearing can be pivoted about a pivot axis, which is arranged parallel to the conveying direction and at a distance from the pivotable embossing wheel.

The disclosure may also relate to a cushioning product formed by means of a stamping gear, sealing gear, pair of embossing gears and/or a forming apparatus according to the disclosure.

According to another aspect of the present disclosure, which is combinable with the preceding aspects and exemplary embodiments, there is provided a cushioning strand comprising a formed section of a single- or multi-layered starting paper web. The cushioning strand has two longitudinal edges extending in the web direction and a, in particular first and/or front, end edge delimiting the cushioning strand in the web direction. It should be understood that the web direction may correspond to a direction in which the starting paper web is conveyed into or through a cushioning material forming apparatus, or a longitudinally extending starting paper web. For example, the starting paper web may be wound into a roll. The web direction then corresponds to the tangential direction to the roll in the region of the starting material taken from the roll. Additionally, or alternatively, the web direction, with respect to the cushioning strand, may correspond to the direction in which the cushioning strand is conveyed in or out of a cushioning material forming apparatus. The cushioning strand further comprises an undulating embossing region extending parallel to the longitudinal edges in the web direction. The embossing region includes, in particular, embossing mountains and embossing valleys and, if appropriate, punching perforations. It may be provided that the embossing region has a plurality of alternating embossing mountains and embossing valleys. Furthermore, the cushioning strand comprises two, in particular transversely to the web direction, opposite tube-shaped cushioning sides adjoining the embossing region transversely to the web direction and extending in the web direction. Preferably, tube-shaped cushioning sides directly adjoining the embossing region are provided on both sides of the embossing region. Optionally, the cushioning sides may be substantially equal in size. The size of the cushioning sides along the longitudinal extension of the cushioning strand in the web direction is preferably substantially constant, wherein it is clear that in the case of irregular cushioning forming, the equality of the cushioning sides may be determined within a tolerance range of <±2 cm, in particular <±1 cm with respect to the respective cushioning tube average radius. Preferably, the embossing region is of constant size in the web direction, preferably within a tolerance range of +1 cm or less, in particular ±0.5 cm or less. Alternatively, or additionally, the cushioning region may have a crumple height which is at least 5 mm, in particular at least 10 mm, preferably at least 15 mm, particularly preferably at least 20 mm, and/or not more than 50 mm, preferably not more than 40 mm, particularly preferably not more than 30 mm.

According to the disclosure it is provided that the cushioning strand has a shrinkage of at least 13% or at least 15%, in particular at least 20%, preferably at least 22%, in relation to the starting paper web. Surprisingly, it has been found that, contrary to the common prejudice according to which an increasing shrinkage can lead to a poorer cushioning quality, in particular for short or compact cushioning strands or cushioning pieces, a very high cushioning effect can be ensured by the cushioning sides, because a higher softness can be provided in this region than in the embossing region, which substantially accommodates the compacting. In particular, it has been found that too small a shrinkage, in particular for compact or small cushioning pieces and strands, can possibly lead to cushioning products that are too soft and cannot provide sufficient shock-absorbing properties for the safe transport of goods.

The cushioning properties can be determined, for example, by placing the cushioning material on a flat, substantially deformation-free surface, such as a metal plate. The cushioning material is then subjected to a two-dimensional load. According to a first alternative, it can be measured what restoring force the cushioning opposes to the two-dimensional load. According to a second alternative, it is possible to measure the deformation distance by which the cushion material is compressed at a predetermined surface load, in particular a reference force related to the loaded reference cushion surface.

According to an exemplary embodiment of a cushioning strand, the shrinkage relates to a shortening of the cushioning material strand in the web direction relative to a starting length of the starting paper web in the web direction. It should be understood that the shrinkage dimension does not refer to a narrowing of the cushioning material strand or piece transversely to the web direction relative to a starting width of the starting paper web transversely to that web direction. Since a fold- or roll-formation for forming of the tube-shaped cushioning sides occurs transversely to the web direction, it is understood by those skilled in the art that substantial changes are always provided transversely to the web direction between the width of the starting paper web and the cushioning strand formed therefrom. Preferably, the shrinkage designates a relation between a starting paper web length and a cushioning material length corresponding thereto in the same web direction. Preferably, the shrinkage denotes the relation of the cushioning length to the starting length along the embossing region.

The disclosure also relates to a cushioning strand consisting of a formed section of a single- or multi-layered starting paper web, which comprises two longitudinal edges extending in the web direction, a, in particular first and/or front, end edge delimiting the cushioning strand in the web direction, and an undulating embossing region extending parallel to the longitudinal edges in the web direction. The undulating embossing region has, in particular, embossing mountains and embossing valleys and, if appropriate, punching perforations. The cushioning strand comprises two opposite tube-shaped cushioning sides adjoining the embossing region transversely with respect to the web direction and extending in the web direction.

According to the disclosure it is provided that the cushioning strand has, transversely with respect to the web direction, a strand width of no more than 12 cm, in particular no more than 10 cm. This much smaller cushioning strand width than known from the prior art allows, for the first time, the use of generic cushioning strands made from the formed section of a starting paper web with opposing tube-shaped cushioning sides laterally enclosing a central embossing region, also for small transport containers in which plastic-based cushioning material is frequently used at present.

Contrary to the prejudice that cushioning material based on a starting paper web with a width of no more than 12 cm is impossible to manufacture without losing the desired cushioning properties, it was possible for the first time to achieve a particularly compact cushioning material that nevertheless provides a high cushioning effect.

According to an exemplary embodiment of the disclosure, the longitudinal edges are each formed by a rolled-up winding section of the starting material web, wherein the starting material web is preferably single-layered. In particular, the longitudinal edges are each formed by a single rolled-up winding section. Additionally, it will be alternatively provided that the longitudinal edges are formed by a single rolled-up winding section (with no more than one winding). Surprisingly, it has been found that for compact cushioning strands or pieces, the use of rolled-up winding sections is preferable. In the prior art, high care is often taken to ensure that the longitudinal edges are formed by multiple rolled-up, wrapped and/or folded winding sections of the starting material wall because, according to a common prejudice, it is assumed that the use of multiple layers and/or windings should be mandatory in order to set desired cushioning properties as safe. However, it has been found that this assumption is based on the widespread inability to ensure safe and continuous embossing stabilization of the opposing tube-shaped cushioning sides even when it must be ensured that merely a single and/or one-time winding layer is to be stabilized. It should be understood that the cushioning strand(s) according to the disclosure are free of adhesive or other chemical and/or physical bonding agents for attaching different layers and/or sides of the starting paper webs to each other.

In an exemplary embodiment of the disclosure, it is provided that at least one winding section, in particular both winding sections of the starting material web opposite each other transversely to the web direction, is held in four layers at least in transverse sections in the embossing region. Preferably, the starting paper web in this embodiment is single-layered. The four-layered holding of the winding section of the starting paper web is achievable by providing at least two layers of a first, with respect to the web direction, transversely thereto right or left winding section; by further providing a further layer in the embossing region by the central region of the starting paper web; and by further providing at least one further layer by paper of the starting paper web from a section, for example a second winding section, opposite to the first winding section with respect to the starting paper web central region. Alternatively, both the first, right winding section and the second, left winding section may provide at least two layers and the starting paper web center region may provide a fifth layer, which are connected together in the embossing region. Particularly preferably, the right winding section and the left winding section may have at least one concave fold and/or tab, formed by a transverse collision with the opposite winding section, which may sectionally provide further layers in the embossing region, which may be secured to each other by embossing. For example, in the embossing region, a sectionally nine-layered support of a cushioning strand or piece starting from a single-layered starting paper may be preferred. The embossing region may have a deformation region width which is at least 10 mm, in particular at least 15 mm, preferably at least 20 mm, and/or which is not more than 50 mm, in particular not more than 35 mm, preferably not more than 30 mm, particularly preferably not more than 25 mm. The embossing region height of the embossing region may relate to the height between the respective pair of embossing mountains and embossing valleys, in particular a pair of adjacent embossing mountains and embossing valleys.

According to an exemplary further embodiment of the disclosure, a tab of a first, for example, right winding section is received in a concave fold of a second, for example, left winding section in the embossing region. According to an exemplary embodiment, which can be combined with the previous embodiment(s), at least one tab can be folded against itself in the embossing region.

The disclosure also relates to a cushioning piece comprising a cushioning strand formed as described above. The cushioning piece has a second, in particular rear, end edge. A cushioning strand generally refers to a continuous coherent band formed from a formed section of a starting paper web. For example, a cushioning piece may be separated from a cushioning strand by a cutting tool such as a rotary blade, guillotine, by manual tearing along a preferably toothed blade, or the like, wherein the process of separating a cushioning piece from a cushioning strand leads to the formation of the cushioning piece and a new cushioning strand.

The cushioning piece preferably consists of a formed section of a single- or multi-layered paper web. In particular, the cushioning piece has two longitudinal edges extending in the web direction, a first and/or front, end edge delimiting the cushioning strand in the web direction and a second and/or rear, end edge. It should be understood that the first end edge is opposite the second end edge in the web direction. The piece length of the cushioning piece is determinable from end edge to end edge. The cushioning piece further comprises an undulating embossing region extending substantially parallel to the longitudinal edges in the web direction. The embossing region of the cushioning piece comprises at least one embossing mountain and/or at least one embossing valley. The embossing region of the cushioning piece optionally comprises at least one punching perforation. The cushioning piece comprises two opposite tube-shaped cushioning sides adjoining the embossing region transversely to the web direction and extending in the web direction.

In relation to a starting length of the starting paper web, the cushioning piece may have a cushioning piece length with a shrinkage of at least 13% or at least 15%, in particular at least 20%, preferably at least 22%. Additionally, or alternatively, the cushioning piece has, transversely with respect to the web direction, a piece width of no more than 12 cm, in particular no more than 10 cm. As soon as a cushioning piece is formed from a cushioning strand, it may be preferred that the piece width of the cushioning piece corresponds to the strand width of the cushioning strand.

According to an exemplary embodiment of a cushioning piece according to the disclosure, the piece width is greater than the piece length. It should be understood that the piece length denotes the extension of the cushioning piece in the web direction and the piece width denotes the extension of the cushioning piece transversely to the web width. The piece length preferably denotes the extension of the cushioning piece along the embossing region. The piece width of a cushioning piece may denote the transverse extension of the cushioning piece, which extends across the opposing tube-shaped cushioning sides and the embossing region provided therebetween. It may be preferred that the piece width is determined according to the flank extension direction of the embossing mountains and/or valleys.

In the past, the guiding principle was that it was absolutely necessary to always provide a piece length of cushioning pieces in the web direction along the embossing regions that was greater than the piece width of the corresponding cushioning piece in order to achieve sufficient cushioning material quality. With the cushioning piece according to the disclosure, however, a stable and high-quality cushioning quality can be achieved even for those cushioning pieces where the piece width is greater than the piece length, for example at least twice as large, at least three times as large, or at least four times as large. By providing particularly short cushioning pieces with a short piece length, it is possible in this way for the first time to provide particularly small generic cushioning pieces which are formed from two tubular cushioning regions and an embossing region provided therebetween. In view of the possible short piece lengths, the cushioning tubes are correspondingly short at the side of the embossing region and approach an annular shape whose winding diameter, contrary to the previous state of the art, is no longer smaller than the piece length but can be the same size, in particular even larger.

According to an exemplary embodiment of a cushioning piece according to the disclosure, the cushioning piece has a piece length of not more than 30 cm or not more than 25 cm, in particular not more than 15 cm, preferably not more than 10 cm or not more than 5 cm, particularly preferably not more than 3 cm.

Additionally, or alternatively, the cushioning piece has a piece length of at least 1.5 cm or at least 2 cm, in particular at least 5 cm, preferably at least 8 cm. Additionally or alternatively, the cushioning piece has a piece width of at least 4 cm or 5 cm, in particular at least 8 cm, preferably at least 10 cm. Particularly preferably, the cushioning width can be in a range of 7 cm to 10 cm, more preferably in the range of 8 cm to 9 cm.

According to an exemplary embodiment of a cushioning piece, the cushioning piece comprises a section of a single-layered starting paper web. It should be understood that the term “section” in reference to the separation of a cushioning piece from a starting paper web also refers to those cushioning pieces that have been separated by a process other than cutting, such as tearing.

The disclosure also relates to a cushioning material forming apparatus for forming a single- or multi-layered starting paper web into a cushioning material in the form of a cushioning strand or cushioning piece, as described above.

According to an exemplary embodiment of a cushioning material forming apparatus, the latter comprises at least one embossing device for forming the embossing region, wherein in particular the embossing device comprises a perforation device for introducing punching perforations into the cushioning material, in particular in the region of an embossing region formed by the embossing device, preferably exclusively in the embossing region. The embossing device can preferably be designed to form a cushioning material from a cushioning material starting paper web, which is formed on both sides of a central embossing region with tube-shaped cushioning sides extending in the web direction. The embossing region can be formed by introducing a plurality of embossing mountains and embossing valleys into the cushioning material.

In an exemplary embodiment of a cushioning material forming apparatus, the latter comprises at least one preforming station for rolling-in the winding sections opposite one another transversely to the web direction of the starting paper web. The preforming station and the embossing device are matched with one another in such a way that the rolled-up winding sections push against one another transversely to the web direction in an infeed region of the embossing device. The infeed region of the embossing device can have a width corresponding to a gear width of the embossing device. Alternatively, the infeed region may be wider than the gear width. The infeed region can have a longitudinal extension which, in the web direction starting from an engagement point where the outer circumferential curves of the intermeshing embossing tools come into contact with each other, counter to the web direction is upstream for a length not greater than the radius of an embossing wheel, preferably not greater than half the radius.

According to an exemplary further development of a cushioning material forming apparatus, the embossing device comprises two embossing rollers meshing into one another. In particular, the embossing rollers comprise a plurality of axial segments. In particular, at least one embossing roller comprises at least one punching segment arranged in the axial direction adjacent to at least one embossing segment for introducing punching perforations into the embossing region. In particular, at least one embossing roller comprises a punching segment arranged in the axial direction between two embossing segments for introducing punching perforations into the embossing region. Preferably, both embossing rollers each have at least one axial embossing segment for introducing punching perforations into the embossing region.

According to an exemplary embodiment, the embossing rollers can have outer axial segments in the axial direction, which have an at least sectionally rounded transition from the axial front face to the circumferential face. Preferably, a rounded transition is provided, in particular only, on the teeth, preferably only in the region of the tooth tips. In particular, the transition may be fully rounded. It has been shown that embossing rollers of this type are particularly suitable for preventing tearing of the thin, single-layer starting material web and thus for ensuring a high cushioning material quality even with a small cushioning width and/or length.

According to another further development of a cushioning material forming apparatus according to the disclosure, the latter comprises a take-off device which communicates a conveying speed to the starting paper web arranged or arrangeable in the starting material supply, wherein in particular the take-off device is arranged upstream of the embossing device in the conveying direction and/or is provided separately from the embossing device. In particular, the embossing device and the take-off device are matched to one another, preferably synchronized, for tension relief of the starting paper web in the region of the embossing device and/or possibly in the infeed region.

According to a further embodiment of a cushioning material forming apparatus, it may be provided that the cushioning material forming apparatus has a receptacle for the starting material supply of the starting paper web, in particular of the starting paper web in the form of a, preferably coreless, roll.

In an exemplary embodiment of a cushioning material forming apparatus, the cushioning material forming apparatus has a separating device arranged immediately downstream of the embossing device in the conveying direction for separating cushioning pieces from a cushioning strand and, if appropriate, a removing device arranged immediately downstream of the separating device for gripping separated cushioning pieces. It may be preferred that the conveying direction corresponds to the web direction.

A forming apparatus according to the disclosure is generally provided with the reference sign 1. A pair of embossing gears according to the disclosure is generally provided with the reference sign 3. A stamping gear according to the disclosure is generally provided with the reference sign 100. A sealing gear according to the disclosure is generally provided with the reference sign 200.

The pair of embossing gears 3 according to the disclosure in the exemplary embodiment shown here is composed of a stamping gear 100 according to the disclosure and a sealing gear 200 according to the disclosure. It should be understood that a pair of embossing gears according to the disclosure can also be realized with one or two gears other than those shown.

FIG. 1 shows a side sectional view of the forming apparatus 1 with a pair of embossing gears 3 consisting of a stamping gear 100 and a sealing gear 200, which roll meshing into one another. The web material, which is not shown in greater detail, is conveyed from the right in the conveying direction F through the preforming device 9 to the pair of embossing gears 3, as shown in the figure. From the pair of embossing gears 3, the cushioning product 2, which is not shown in greater detail, is dispensed in the conveying direction F. A frame 5 supports the pair of embossing gears 3 and the preforming device 9.

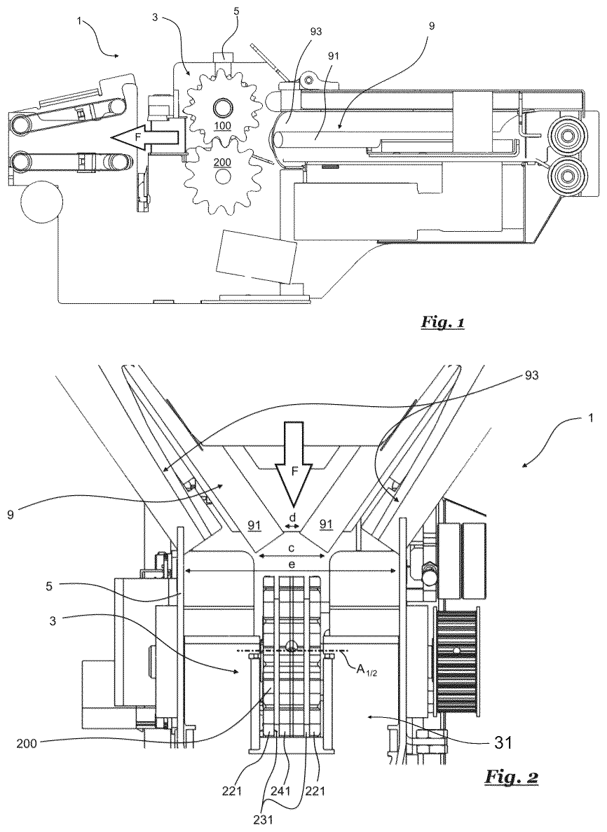

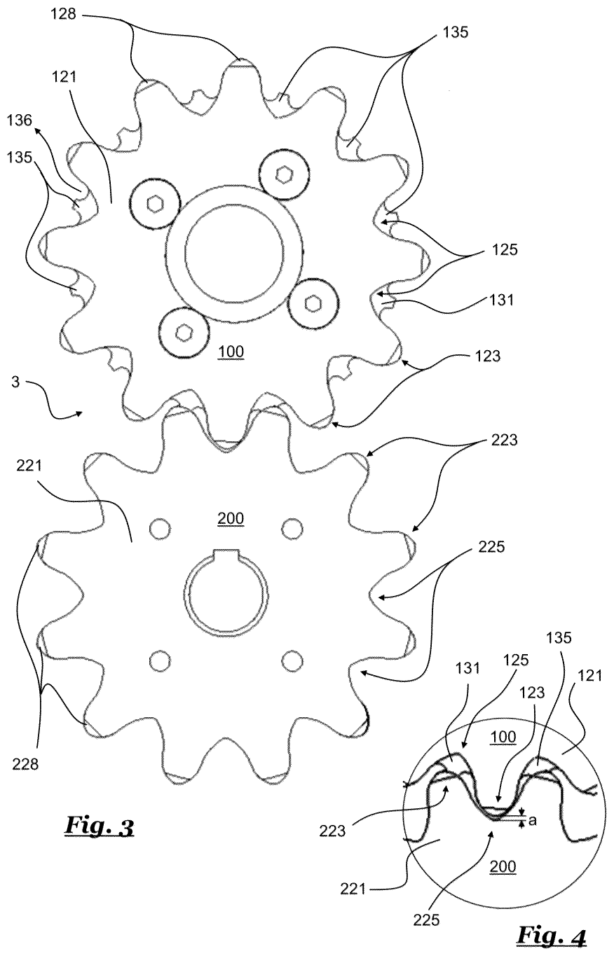

FIG. 2 shows a sectional plan view of the forming apparatus 1. The web material, which is not shown in greater detail, is brought to the pair of embossing rollers 3 in the conveying direction F by the preforming device 9. The preforming device comprises a preforming funnel 93 and mutually opposing converging guide rods 91 in the conveying direction F. A bar spacing d is provided between the guide rods 91 at their embossing roller pair side end, which is not undershot. The bar spacing d can be in the range of about 5 mm to about 15 mm, for example about 7 mm. The, in the conveying direction F, front ends of the guide rods 91 determine a dispensing distance c. The dispensing distance is in the range of about 20 mm to about 50 mm, preferably about 30 mm. The preforming device 9 is adapted and arranged to wrap or roll up inwardly the, transversely to the web direction opposite, outer longitudinal edges, of a web material which is moved in conveying direction F through the preforming device 9. The guide rods 91 serve to guide the rolled-up or wrapped-in longitudinal sections of the web material. The preforming device 9 substantially determines the later transverse width of the cushioning product 2 transversely to the conveying direction F.

The pair of embossing rollers 3 is adapted and arranged for introducing alternating embossing mountains and valleys in a central region of the preformed web material, as well as punching's if necessary, to form the cushioning product 2. In the region of the pair of embossing rollers 3, the frame 5 is formed with a channel width e that may correspond to the starting width of the preform funnel 93. The channel width e is in the range of about 50 mm to about 200 mm, in particular in the range of about 80 mm to about 120 mm, preferably about 100 mm.

The pair of embossing gears 3 is arranged centrally in the channel 31. The pair of embossing gears 3 is rotatably mounted on the frame 5. Preferably, it can be provided that one driven gear wheel, in particular the sealing gear 200, is held stationary on the frame 5 and the other gear wheel, in particular the stamping gear 100, is held spring biased by a spring device 7 shown below with reference to FIG. 10. The gear wheels 100, 200 are mounted on the frame 5 with parallel gear axes A₁, A₂. The stamping gear 100 has a stamping gear axial width b1 and the sealing gear has a sealing gear axial width b₂. The axial width b₁ of the stamping gear 100 can be as large as or smaller than the axial width b₂ of the sealing gear 200. The axial width b₁, b₂ of the gears is substantially equal to the dispensing distance c of the preforming device 9, wherein the axial width of the gears may be slightly less than the dispensing distance c. For example, the axial width b₁, b₂ can be in the range 20 mm to 50 mm, preferably in the range 25 mm to 30 mm. The axial width b₂ of the sealing gear 200 can be as large as or slightly larger than the axial width b of the stamping gear 100, for example about 0.5 mm wider.

With reference to FIGS. 3 to 11, the structure and operation of a pair of embossing gears 3 consisting of a stamping gear 100 and a sealing gear 200 are described in detail.

The stamping gear 100 as well as the sealing gear 200 are composed of segments illustrated in FIGS. 7 to 9. In the exemplary embodiment shown in the figures, both the stamping gear 100 and the sealing gear 200 use partially the same segments, namely outer segments 121 and 221, respectively, and center segments 141 and 241, respectively. Only the stamping gear 100 comprises stamping segments 131 with embossing teeth, and only the sealing gear 200 comprises sealing segments 231. The segments have a disk-like structure and a respective axial width. Although in the exemplary embodiment shown the various disk segments are each formed in one piece, according to an alternative embodiment, one or more of the segments shown could be formed as multiple pieces, for example by a plurality of disks lying axially on top of each other.

The punching nose width or punching segment axial width a₁₃ is smaller than the sealing segment axial width a₂₃. The sealing segment axial width a₂₃ defines an axial opening width into which the punching noses of the stamping segment 131 can penetrate the sealing gear 200. If the opening width is too wide, the web material is sometimes not perforated, but merely drawn through the gap in the conveying direction F. If the opening is dimensioned too narrow, there is a risk that a punching nose will jam between the edge segment 221 and/or center segment 241 adjacent to the sealing segment 231. It has proved advantageous to dimension the sealing segment axial width a₂₃ 0.05 mm to 0.3 mm, in particular 0,075 mm to 0.2 mm, preferably about 0.1 mm to 0.15 mm wider than the width of the punching noses or the stamping segment axial width a₁₃.

FIG. 3 shows the gear wheels of the pair of embossing gears 3 meshing into one another and FIG. 4 shows in detail the radial distance a between them. As can be seen in FIG. 4, the lower gear wheel, which is shown here as a sealing gear 200, is rotated counterclockwise in the conveying direction F to convey the web material. When no web material is loaded, as in the example shown, the driven gear wheel comes into tangential contact with the free-running gear wheel, here the stamping gear 100, in order to take it along. This can result in tangential contact between the tooth flanks. Between the tooth heads of the embossing teeth 123, 223 of one gear wheel and the valley base 225, 125 of the other gear wheel, there always remains a radial distance with a distance width a. This radial distance can be occupied with the web material or cushioning product 2.

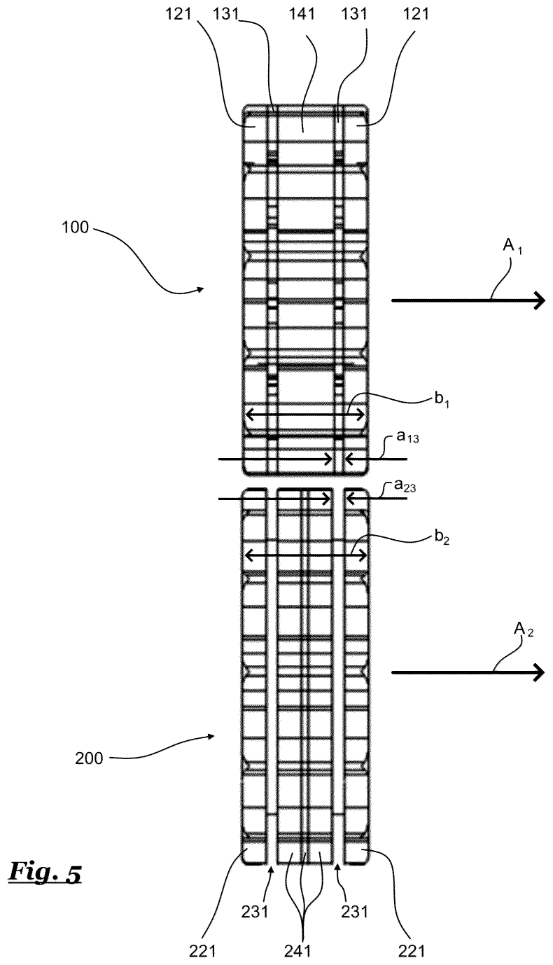

FIG. 5 shows a view of the pair of embossing gears 3 with the viewing direction corresponding to the conveying direction. The stamping gear 100 has an axis of rotation that defines the axial direction A₁. The sealing gear 200 has an axis of rotation defining the axial direction A₂. In the forming apparatus 1 according to the disclosure, the rotational axis of a gear wheel, for example of the sealing gear 200, can be fixed in position and the other rotational axis can be movably mounted with a spring device 7 transversely to the axial direction (here: A₁) and transversely to the conveying direction F. The axis of rotation and thus the axial direction A₁, A₂ of the stamping gear 100 and the sealing gear 200 are oriented parallel.

In the axial direction A1, the exemplary stamping gear 100 shown here is composed of a first edge segment 121, a first stamping segment 131, a center segment 141, a second stamping segment 131, and a second edge segment 121. In the axial direction A₂, the exemplary sealing gear 200 shown here is composed of a first edge segment 221, a first sealing segment 231, three center segments 241, a second sealing segment 231, and a second edge segment 221.

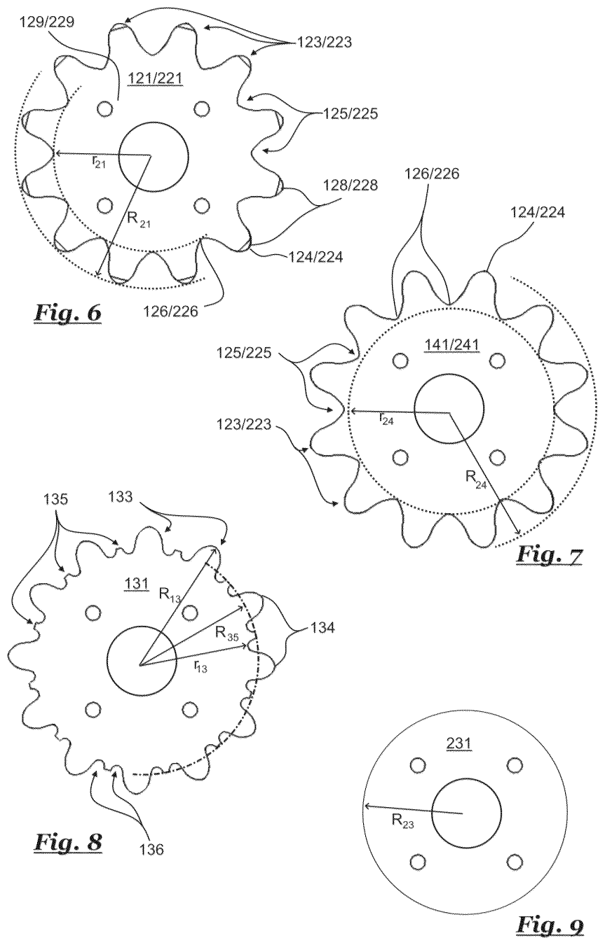

For simplicity, cross-sectionally congruent edge segments 121, 221 and center segments 141, 241 are shown in FIGS. 6 and 7 below, respectively. It is understood by those skilled in the art that the gears or segments of the various gears are not necessarily congruently shaped. For case of reading, reference is made below to only one of the relevant reference signs.

FIG. 6 illustrates an edge segment 121 in view of the outer side surface 129. The edge segment 121 comprises alternating embossing teeth 123 and embossing valleys 125. A transition region 128 from the tooth head 124 to the axial outer side surface 129 is provided on each embossing tooth 123, which in the present embodiment is formed by a radius, wherein the radius is in the range from 1 mm to 20 mm, preferably in the range 2 mm to 10 mm. No transition region is provided in the region of the tooth base or valley base 126. The radially innermost location of the valley base 126 determines an edge segment inner radius r₂₁. The radially outermost location of the tooth head 124 determines the edge segment outer radius R₂₁. The inner side surface opposite the outer side surface 129 has the same shape as the center segment 141 described below with reference to FIG. 7.

FIG. 7 shows a center segment. The axial outer sides of the center segment are flat and preferably oriented at a right angle with respect to the gear axis. The center segment 141 includes alternating embossing teeth 123 and embossing valleys 125. The radially innermost location of the valley base 126 determines a center segment inner radius r₂₄. The radially outermost location of the tooth head 124 determines a center segment outer radius R₂₄.

The cross-sectional shapes of the center segment 141 and the edge segment 121 of the stamping gear 100 are the same, in particular congruent. The cross-sectional shapes of the center segment 241 and the edge segments 221 of the sealing gear 200 are the same, in particular congruent.

FIG. 8 shows a stamping segment 131. A plurality of punching noses 135 are arranged around the outer circumference of the stamping segment 131. A tooth section 133 is arranged between adjacent punching noses 135. On the stamping segment 131, tooth sections 133 and punching lugs 135 are arranged circumferentially alternately around the outside. It may be preferred that a depression 136 is provided between adjacent tooth sections 133 and punching noses 135, wherein the depressions 136 define a stamping segment inner radius r₁₃ which is smaller than the punching nose radius R₃₅. The tooth heads 134 of the tooth sections 133 define a stamping segment outer radius R₁₃ at the outermost location with respect to the axis of rotation. The punching noses 135 define a punching nose radius or punching radius R₃₅. It is conceivable that the punching noses 135 without countersinks 136 extend continuously, preferably circularly, between the adjacent tooth sections 133 (along the dash-dot line).

The punching nose radius R₃₅ is smaller than the stamping segment outer radius R₁₃ and smaller than the outer radius R₁₃, R₂₄ of the edge section and/or the center section. The punching nose radius R₃₅ is larger than the inner radius r₁₃, r₂₄ of the edge section and/or the center section.

In the exemplary embodiment shown here, the inner radii r₁₃, r₂₁, r₂₄ of the edge segment 121, the center segment 141 and the stamping segment 131 are the same size. Similarly, the outer radii R₁₃, R₂₁, R₂₄ of the edge segment 121, the center segment 141 and the stamping segment 131 are the same size. The cross-sectional shapes of the embossing teeth 123 and the tooth sections 133 are the same, in particular congruent.

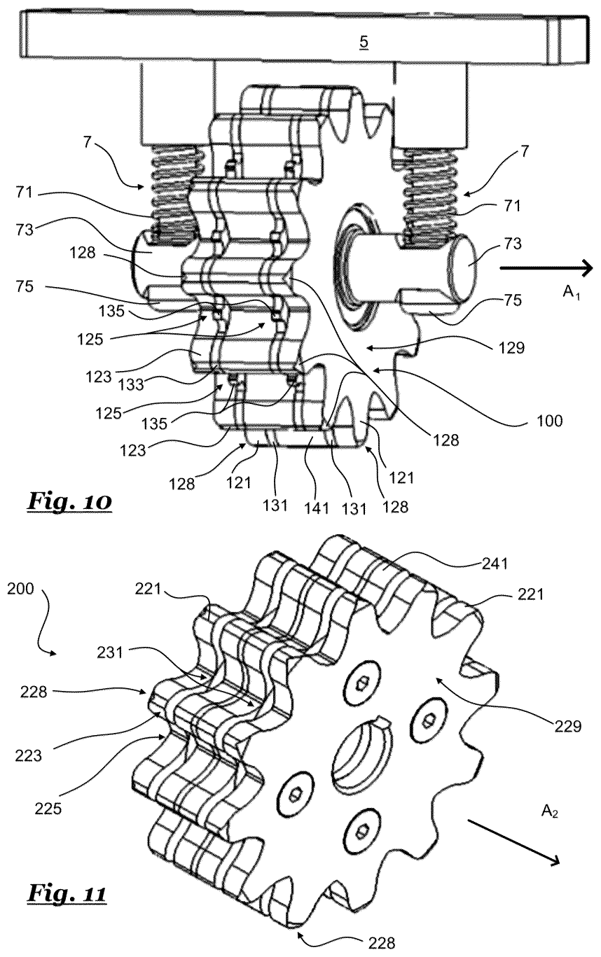

FIG. 9 shows a sealing segment 231 which, in the embodiment illustrated here, is shown in an annular shape with a constant outer radius R₂₃. The sealing segment outer radius is always smaller than the outer radius R₂₁ and/or R₂₄ of the edge segment 221 and the center segment 241. Preferably, the sealing segment outer radius R₂₃ is substantially equal to or identical to the inner radius r₂₁ and/or r₂₄ of the edge segment 221 and the center segment 241. With respect to the stamping segment 131, the outer radius R₂₃ of the sealing segment 231 is preferably matched with respect to the punching nose radius R₃₅, in particular such that a radial stamping distance remains between the punching nose radius R₃₅ and the sealing segment outer radius R₂₃ in the operational state of the pair of embossing gears 3, wherein in particular the radial stamping distance is at least as large as the distance width a of the radial distance. It should be understood that the sealing segment could have, for example, an undulating outer edge which locally has a smaller radius than the outer radius R₂₃ (not shown in more detail).

In the exemplary embodiment shown here, the inner radii r₂₁, r₂₄ of the edge segment 221, the center segment 241 and the outer radius R₂₃ of the sealing segment 231 are the same size. Also, the outer radii R₂₁, R₂₄ of the edge segment 121 and the center segment 141 are the same size.

FIGS. 10 and 11 show perspective views of the gear wheels 100, 200 and their segments described previously with respect to the preceding FIGS. 3 through 5 and described above in FIGS. 6 through 9.

FIG. 10 also shows the spring device 7 with which the stamping gear 100 is held on the frame 5. The spring device 7 comprises compression springs 71 which bias an axle 73 of the stamping gear 100 against a counter bearing 75 with a spring force.

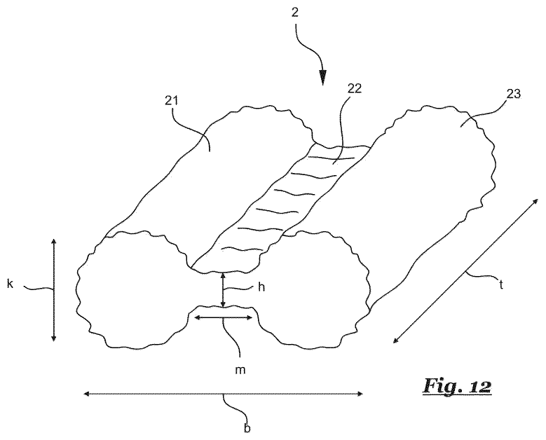

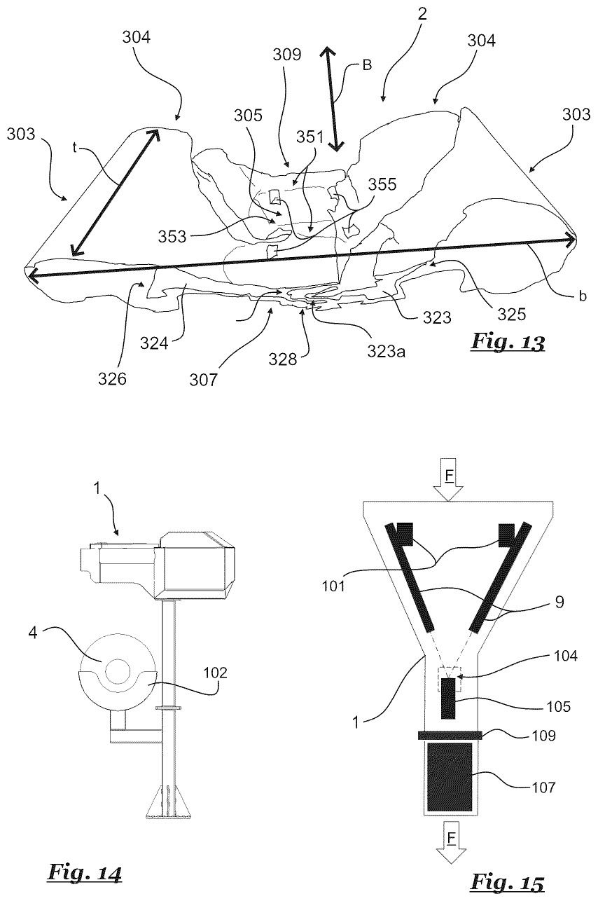

FIG. 12 shows a schematic representation of a cushioning product 2 according to the disclosure, which is produced from a web-shaped starting material by means of an apparatus 1 according to the disclosure and/or whose cushioning width b dimensioned transversely to the longitudinal direction of the web or conveying direction F is less than 12 cm, whose cushioning length t in the longitudinal direction of the web is less than 30 cm, whose vertical extension k lies in the range from 2 cm to 3 cm. The cushioning product 2 comprises two lateral cushioning regions or crush cavities 21, 23 extending in the longitudinal direction of the web, which are formed by radially inward folding or inward rolling of lateral starting material web sections of the starting material. Further, the cushioning product 2 includes a central fastening and/or deformation zone 22 in which the folded-over starting material web sections overlap and are bound together. A width m, measured in the width direction, of the fastening and/or deformation zone may be in the range of 2 cm to 2.5 cm, the vertical extension h of which is below 1.5 cm or below 1 cm.

A cushioning piece according to the disclosure is generally designated by the reference sign 2. A cushioning material forming apparatus according to the disclosure is generally denoted by reference numeral 1. The cushioning piece comprises a piece of a single layered starting paper web, two longitudinal edges 303 extending in the web direction, a front end edge 307 and a rear end edge 309 opposite the front end edge 307. The cushioning piece has a central undulating embossing region 305 extending in the web direction B and, on each side of the embossing region, a tube-shaped cushioning side 304 adjoining the embossing region and extending transversely to the web direction. The embossing region has a plurality of embossing mountains 351 and embossing valleys 353 and, if appropriate, punching perforations 355.

The cushioning piece 2 is formed by dividing, preferably cutting or tearing, from a cushioning strand formed from a web-like paper starting material in a cushioning material forming apparatus 1. The cushioning material strand differs from the cushioning piece 2 substantially in that the cushioning piece has a certain cushioning length t, whereas the cushioning strand has a front end 307, but in the cushioning material forming apparatus 1 transitions, against the conveying direction F, into the endless or quasi-endless starting material 4.

To the conveying direction F by the cushioning material forming apparatus, the embossing region 305 is formed in the conveying direction F and the web direction B corresponding thereto. The cushioning length t is defined in the web direction B from the front end 307 to the rear end 309 of the cushioning piece 2.

Transversely to the web direction B, the cushioning piece has a piece width b which generally corresponds to the strand width. In the transverse direction, the cushioning piece 2 can be divided into the central embossing region 305 and the cushioning sides 304 provided on both sides of the embossing region 305. In the region of the cushioning sides 304, the starting paper web 4 is formed into a tube-shape. The tube shape is realized by a respective winding section 323 or 324, which is formed starting from the longitudinal marginal edge of the starting material web by wrapping inwardly. The cushioning piece 2 has a right winding section 323, a left winding section 324 and the central embossing section 305. The cushioning piece 2 has been formed from a single-layered starting paper web 4. In the region of the winding sections 323, 324, the cushioning piece 2 is predominantly two-layered. In the embossing region 305, the cushioning piece 2 is at least four-layered, in that, on top of each other, at least the right or the left winding sections 323, 324, a longitudinal wall end 325, 326 opposite thereto as well as the winding section 328 of the starting paper web lie one above the other.

Adjacent to the embossing region 305, three-layered regions are present in the cushioning sides 304 in which, in the winding 323 or 324, the folded-in longitudinal wall edge 325 or 326 is arranged.

The embossing region 305 is formed by embossing mountains 351 and embossing valleys 353 alternately introduced into the cushioning strand or cushioning piece 2. The introduction of embossing mountains 351 and embossing valleys 353 can occur, for example, by an embossing device 105 of the cushioning material forming apparatus 1, which can be formed, for example, by meshing embossing rollers. Furthermore, punching perforations 355 can be introduced in the embossing region 305, which completely or partially penetrate the cushioning strand or cushioning piece 2 transversely to the web direction. The punching perforations serve to frictionally connect the plurality of layers of the starting material web 4 arranged in the embossing region 305 in order to prevent or at least make it more difficult for the cushioning strand or cushioning piece 2 to unfold.

The cushioning material forming apparatus 1 may include a preforming station 9 upstream of the embossing device 105. The preforming station 9 may comprise a funnel-shaped inlet and/or a central guide, for example a guide plate and/or guide rods. The web material is led through the preforming station 9 in the conveying direction F, wherein the longitudinal marginal edges 325 and 326 of the starting material web 4 are wound inwardly transversely to the web direction B so that the windings 323 and 324 form.

The embossing device 105 and the preforming station 9 are preferably matched with one another in such a way that the preforming station 9 pushes the winding sections 324 and 325 against each other in an infeed region 104 at the entrance to the embossing device 105. As a result of the winding sections 323 of the single-layered starting paper web 4 being pushed against each other, concave folds are formed in the embossing region 305 where the opposite winding section 323 pushes against the aforementioned winding section 324 so that the latter is radially collapsed. In this regard, a tab 323a of the second winding section 323 may transversely push against an outer surface of the first winding section 324 and form a concave fold 324a in said winding section 324. The fold 324a forms an additional double layer.

Additionally, or alternatively, tabs 323a, as shown in the examples in FIG. 13, may be urged to fold in against themselves by the resistance of the opposite winding section 324. In this regard, a tab 323a may be folded in against itself. Like a concave fold 324a, a tab 323a folded in against itself also forms an additional double layer in the embossing region 305.

It should be understood that in the web direction B along the embossing region 305, a plurality of tabs 323a, in particular tabs 323a folded in against themselves, as well as concave folds 324a may be formed in random sequence. Along a unit length of 1 m along the embossing strand, at least 5, at least 10 or at least 20 concave folds 324a and/or tabs 323a folded in against themselves may be formed. Along the cushioning piece 2 or the cushioning strand in the web direction B, continuous tabs 323a and/or folds 324a are formed at least along 30%, preferably at least along 50%, in particular at least along 75% or along the entire length of the embossing region 305. In this way, a multilayer structure can be formed in the region 305 from a single-layer starting paper web 4, which ensures a particularly stable cushioning material from a single-layer starting paper web.

The cushioning material forming apparatus may be provided with a take-off device 101, which is adapted and arranged to take off the starting paper web 4 from a receptacle 102 and to convey it into the cushioning material forming apparatus 1 (FIGS. 14 and 15). It may be preferred that the take-off device 101 and the embossing device 105 are matched to one another in such a way that the paper starting material 4 is tension-relieved in the region of the infeed 104 or the embossing device 105.

Downstream of the embossing device 105, a separating device 109, e.g. a guillotine, can be provided and a removing device 107 provided downstream of the separating device 109 in the direction of conveying flow F, which grips individual cushioning pieces 2 and ejects them from the cushioning material forming apparatus.

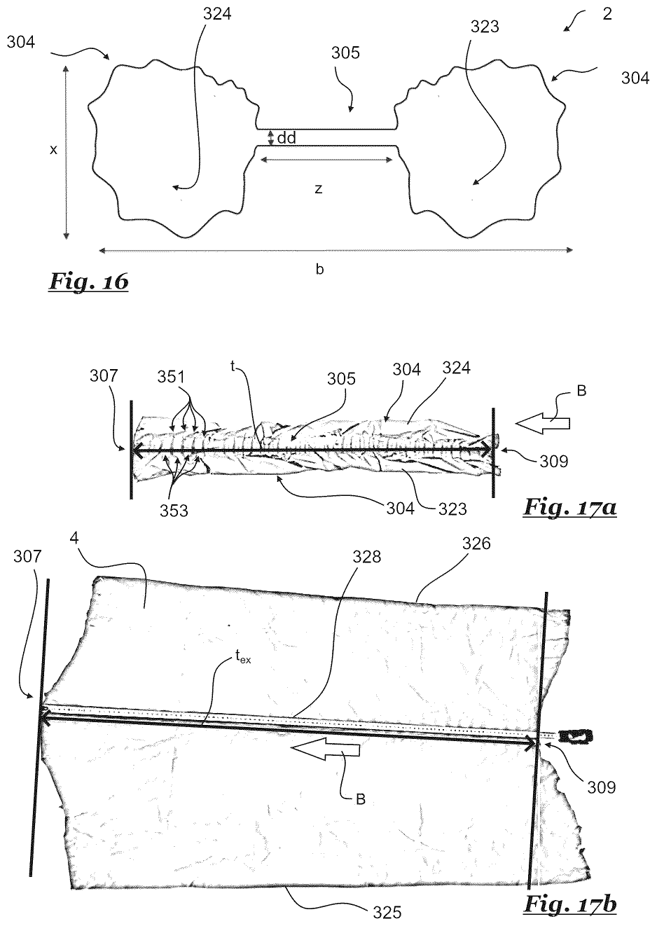

FIG. 16 shows a schematic cross-sectional view of a cushioning strand or piece 2 according to the disclosure. The cushioning piece 2 has a cushioning width b in the range of about 8 cm to 9 cm. The tubular cushioning pads on the cushioning sides 304 on opposite sides of the cushioning piece 2 are formed into windings 323, 324. The cushion sides 304 have a crumple height x in the range of about 20 mm to about 30 mm. The thickness d in the region 5 is much smaller than the crumple height x. The thickness dd is preferably in the range <10 mm, in particular <5 mm. The thickness dd can be determined, for example, in the region of a reversal point of either the cushion valley or the cushion mountain. The width z of the deformation region 305 is preferably in the range of 20 mm to about 25 mm. At least one of the cushioning sides 304 has a greater transverse width than the deformation width z of the embossing region 305. Preferably, both the right cushioning side 304 and the left cushioning side 304 have a greater crumple region width than the deformation region width z. Preferably, the crumple region widths at the left cushioning side 304 and the right cushioning side 304 are substantially equal. Particularly preferably, the crumple region width may correspond to the crumple region height x.

FIGS. 17a and 17b serve to illustrate the determination of the cushioning length t and the corresponding paper web length tex, respectively. Both the cushioning length t and the paper web length tex must always be measured centrally in the area of the embossing region 305. The shrinkage S can be determined with the following formula:

S=1−t/tex.

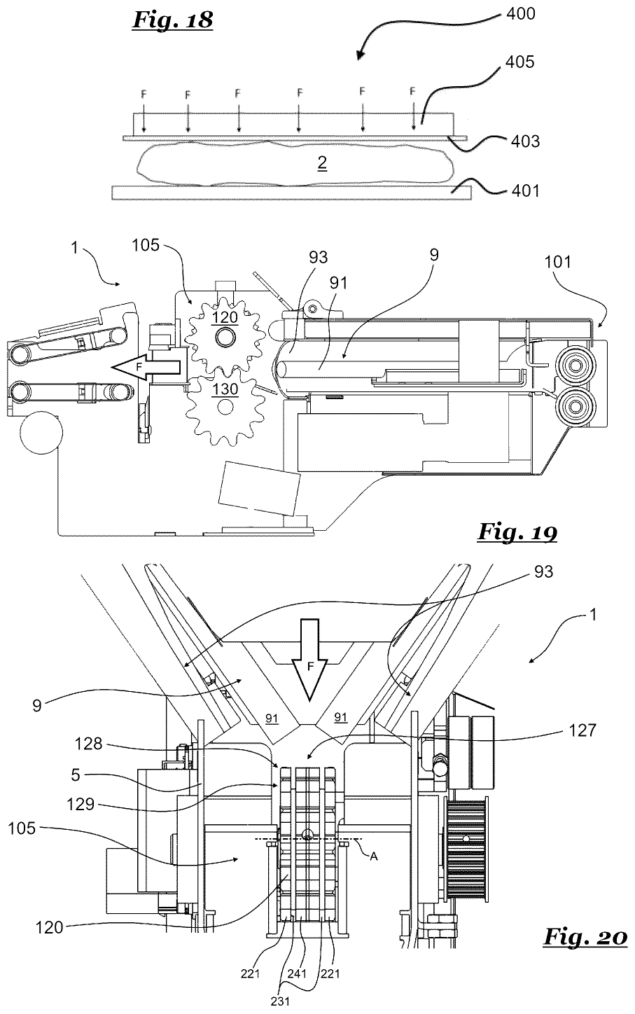

FIG. 18 illustrates a measurement setup 400 for determining cushioning properties. The cushioning material 2 is placed on a flat, substantially deformation-free surface 401, such as a wooden or metal plate. Next, the cushioning material 2 is subjected to a two-dimensional load. According to a first alternative, it can be measured what restoring force the cushioning opposes to the two-dimensional load. According to a second alternative, it can be measured by which deformation distance the cushion material is compressed at a predetermined surface load, in particular a reference force related to the loaded reference cushion surface. In the following tables, Table A shows measurement results for various cushioning materials according to the disclosure made from a paper web material with a grammage of 70 g/m² (Table A; hereinafter “Cushion A”) and a grammage of 90 g/m² (Table B; hereinafter “Cushion B”). The paper web materials have a web width of 350 mm. In its initial state, Cushion A has a cushioning height of approx. 33 to 34 mm, Cushion B a cushioning height of approx. 34-36 mm.

For measurement, a starting height h0 corresponding to the crumple height x of an unloaded cushion material is first determined. For this purpose, the crumple height x is measured on a lightweight, loosely supported planar support plate 403 in the unloaded starting state. For example, h0 can be an average value determined from measurements at 4 measuring points. For example, a 100 mm×270 mm plate approximately 4 mm thick plate, e.g. made of dimensionally stable corrugated cardboard, can be used as a support plate.

Then h1 is determined: For this purpose, the test load 405 is placed on the support plate 403 and loaded for 10 seconds. The height is then measured again at the same measuring points and a mean value h1 is determined from this. Then h2 is determined: The test load is removed from the support plate 403, waited for 10 seconds and again the height is measured at the same measuring points and from this the mean value is determined as h2. The restoring force can then be determined.

Tables A and B below show that the restoring ability of Cushion B is greater than that of Cushion A. After loading, the cushion springs back again. There is no large scatter in the cushioning heights. In the case of Cushion A, an increasing plastic deformation can be detected at higher test loads. For Cushion B, the restoring effect is substantially independent of the test load.

TABLE A

| | | | | | | | | | | | | | | | | | | | | | | | | | | |
|---|---|---|---|---|---|---|---|---|---|---|---|---|---|---|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

TABLE B

| | | | | | | | | | | | | | | | | | | | | | | | | | | |
|---|---|---|---|---|---|---|---|---|---|---|---|---|---|---|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

FIG. 19 shows a side sectional view of the cushioning material forming apparatus 1 with a pair of embossing gears 105 comprising two embossing rollers 120, 130 meshing into one another. The web of paper material, which is not shown in greater detail, is conveyed from the right in the conveying direction F through the preforming device 9 to the pair of embossing gears 105, as shown in the figure. From the pair of embossing gears 105, the cushioning product not shown in greater detail is dispensed in the conveying direction F. A frame supports the pair of embossing gears 105 and the preforming device 9.

FIG. 20 shows a sectional plan view of the cushioning material forming apparatus 1. The paper material web, which is not shown in greater detail, is brought in the conveying direction F by the preforming device 9 to the pair of embossing rollers 120, 130. The preforming device 9 comprises a preforming funnel 93 and mutually opposite converging guide rods 91 in the conveying direction F. The preforming device 9 is adapted and arranged to inwardly wrap or roll up the outer longitudinal edges, opposite transversely to the web direction, of the paper material web which is moved in the conveying direction F through the preforming device 9. The guide rods 91 serve to guide the rolled-up or wrapped-up longitudinal sections of the paper material web. The preforming device 9 substantially determines the subsequent transverse width of the cushioning product transversely to the conveying direction F.

The embossing roller 120 is composed of segments, namely outer segments 221 and center segments 241. The embossing roller 120 further comprises punching segments 231, which may be formed as punching and/or sealing segments. The segments are of disc-like construction and have a respective axial width. Although in the exemplary embodiment shown, the various disk segments are each formed in one piece, according to an alternative embodiment, one or more of the segments shown could be formed as multiple pieces, for example by multiple disks lying axially on top of each other. The exemplary sealing gear 120 shown here comprises, in the axial direction A, a first edge segment 221, a first sealing segment 231, three center segments 241, a second sealing segment 231 and a second edge segment 221.

The pair of embossing rollers 120, 130 is adapted and arranged to introduce alternating embossing mountains and valleys and, if appropriate, punching's, in a central region of the preformed paper material web, to form the cushioning product. On each embossing roller, a transition 128 is provided from the circumferential surface 127 formed by tooth heads to the axial outer side surface 129, which in the present embodiment is formed by a radius, wherein the radius is in the range of 1 mm to 20 mm, preferably in the range of 2 mm to 10 mm.

The features disclosed in the foregoing description, figures, and claims may be significant, both individually and in any combination, for the realization of the disclosure in the various embodiments.

### REFERENCE SIGNS

1 Forming apparatus
2 Cushioning product
3, 105 Pair of embossing gears
4 Starting material
5 Frame
7 Spring device
9 Preforming device
21 Crumple cavity
22 Central fastening and/or deformation zone
23 Crumple cavity
31 Channel
71 Pressure spring
73 Axis
75 Counter bearing
91 Guide rod
93 Preform funnel
100 Stamping gear
101 Take-off device
102 Receptacle
104 Infeed region
105 Embossing device
107 Removing system
109 Separating device
120, 130 Embossing rollers
121 Edge segment
123 Embossing tooth
124 Tooth head
125 Valley
126 Valley base
127 Circumferential surface
128 Transition region
129 Outer side surface
131 Embossing segment
133 Tooth section
135 Punching nose
136 Depression
141 Center segment
200 Sealing gear
221 Edge segment
223 Embossing tooth
224 Tooth head
225 Valley
226 Valley base
228 Transition region
229 Outer side surface
231 Sealing segment
233 Tooth section
235 Punching nose
241 Center segment
303 Longitudinal edge
304 Cushioning side
305 Embossing region
307 front end edge
309 rear end edge
323, 324 Winding section
323a Tab
324a Fold
325, 326 Longitudinal wall
328 Winding region
351 Embossing mountain
353 Embossing valley
355 Punching perforation
400 Measurement setup
401 Surface
403 Support plate
405 Test load
A₁, A₂ Gear axis
A Axial direction
F Conveying direction
B Web direction
S Shrinkage
a Radial distance
b Piece width
a₁₅ Punching noses axial width
a₂₃ Sealing segment axial extension
b1 Gear axial width
b2 Gear axial width
c Dispensing distance
d Rod spacing
dd Thickness
e Channel width
h Vertical extension
k Vertical extension
m Width
t Piece length
tex Paper web length
X Crumple height
Z Width
r₁₃ Stamping segment inner radius
r₂₁ Edge segment inner radius
r₂₄ Center segment inner radius
R₁₃ Punching segment outer radius
R₂₁ Edge segments outer radius
R₂₃ Scaling segment outer radius
R₂₄ Center segment outer radius
R₃₅ Punching nose radius

1. A stamping gear for a pair of embossing gears of an apparatus for forming a web material into a cushioning product, comprising:
a plurality of embossing teeth;
valleys arranged between adjacent embossing teeth of the plurality of embossing teeth; and
punching nose arranged in a region of the valleys, wherein the plurality of embossing teeth are continuous in an axial direction.

2. The stamping gear according to claim 1, further comprising axial outer side surfaces, rounded transition regions being provided between the respective outer side surfaces and a corresponding one of the plurality of embossing teeth.

3. The stamping gear according to claim 1, further comprising a plurality of disk-shaped axial segments including:
two edge segments having the plurality of embossing teeth and the valleys formed between the adjacent embossing teeth;
stamping segments arranged axially between the two edge segments and having punching noses arranged in a region of the valleys, the stamping segments including a plurality of tooth sections corresponding to the plurality of embossing teeth; and
at least one center segment arranged between the stamping segments and being shaped to correspond to the two edge segments.

4. (canceled)

5. A pair of embossing gears for an apparatus adapted to forming a web material into a cushioning product, comprising:
a stamping gear according to claim 1; and
a sealing gear adapted to engage the stamping gear, wherein a radial distance in a range of 0.01 mm to 1 mm is formed between the sealing gear and the stamping gear.

6. The pair of embossing gears according to claim 5, wherein: comprises:
a plurality of disk-shaped axial segments including two edge segments having a plurality of uniform embossing teeth and valleys formed between adjacent embossing teeth; and;
at least one sealing segment arranged axially between the two edge segments and having a rotationally symmetrical shape with respect to a gear axis and/or a maximum sealing segment radial extension which is not larger than a smallest edge segment radial extension in the region of the valleys, the least one sealing segment includes a sealing segment axial extension which is at least as large as an axial width of at least one the punching noses and/or as large as a stamping segment axial extension of a stamping segment of the stamping gear, the sealing segment axial extension being at least 0.1 mm and/or not more than 0.5 mm larger than the axial width of the at least one punching nose or the stamping segment axial extension.

7. (canceled)

8. The pair of embossing gears according to claim 6, comprising: at least two sealing segments arranged between the two edge segments; and at least one center segment arranged between the at least two sealing segments, wherein the center segment is shaped to correspond to the two edge segments.

9. The pair of embossing gears according to claim 5, wherein:
the stamping gear and the sealing gear each have a pair of axial outer side surfaces opposite one another in the axial direction, rounded transition regions being provided between the outer side surfaces and the embossing teeth of the stamping gear and/or of the sealing gear; and/or
the sealing gear is free of punching noses.

10. (canceled)

11. The pair of embossing gears according to claim 5, wherein the sealing gear is a second embossing gear with punching noses, wherein a first of the pair of embossing gears and the second embossing gear of the pair of embossing gears are matched to each other such that: the punching noses of the first embossing gear engage in punching-nose-free embossing-valley axial regions of the second embossing gear, and the punching noses of the second embossing gear engage in punching nose-free embossing valley axial regions of the first embossing gear.

12. (canceled)

13. An apparatus for forming a web material into a cushioning product, the apparatus comprising:
at least one stamping gear according to claim 1; and/or
at least one pair of embossing gears comprising:
the at least one stamping gear; and
a sealing gear adapted to engage the at least one stamping gear, wherein a radial distance in a range of 0.01 mm to 1 mm is formed between the sealing gear and the stamping gear,
wherein the at least one stamping gear is biasedly held on a frame of the apparatus transversely to an axial direction.

14. (canceled)

15. The apparatus according to claim 13, further comprising: a preforming device adapted to introduce turned-over and/or rolled-up cushioning regions along opposite longitudinal marginal edges of the web material, wherein the stamping gear and/or the pair of embossing gears has a gear axial width adapted to engage both cushioning regions, the preforming device including a guide having a dispensing distance equal to or larger than the gear axial width, wherein the apparatus is adapted to dispense a cushioning product with: a piece length of not more than 30 cm; and/or a piece width of at least 4 cm.

16-17. (canceled)

18. A cushioning strand having a formed section of a single- or multi-layered starting paper web, the cushioning strand comprising:
two longitudinal edges extending in a web direction;
an end edge delimiting the cushioning strand in the web direction; and
an undulating embossing region extending parallel to the two longitudinal edges in the web direction,
wherein the cushioning strand has, transversely with respect to the web direction, a strand width of not more than 12 cm.

19. The cushioning Cushioning-strand according to claim 18, wherein:
the undulating embossing region comprises: embossing mountains and embossing valleys, punching perforations, and two opposite, tube-shaped cushioning sides adjoining the embossing region transversely with respect to the web direction and extending in the web direction;
the two longitudinal edges are formed by a respective rolled-up winding section of the starting paper material-web;
at least one of the winding sections of the starting paper web material web is held in four layers at least in transverse sections in the embossing region;
a tab of a first of the winding sections is received in a concave fold of a second of the winding sections in the embossing region; and/or
the tab of the first of the winding sections is folded in against itself in the embossing region.

20-22. (canceled)

23. A cushioning piece comprising a cushioning strand according to claim 18, the cushioning strand including a second end edge, wherein the cushioning piece has a piece length in the web direction and a piece width transversely to the web direction.

24. The cushioning piece according to claim 23, wherein:
the piece width is greater than the piece length; and/or
the piece length is: not more than 30 cm and/or at least 1.5 cm.

25. (canceled)

26. The cushioning piece according to claim 23, wherein:
the piece width is of at least 4 cm; and/or
the cushioning piece comprises of a section of a single-layered starting paper web.

27. (canceled)

28. A cushioning material forming apparatus for forming a single-layered or multilayered starting paper web into a cushioning material in the form of a cushioning strand according to claim 18.

29. The cushioning material forming apparatus according to claim 28, wherein:
the at least one embossing device comprises a perforator adapted to introduce punch perforations into the cushioning material; and
the at least one preforming station is adapted to roll-in the two winding sections opposite one another transversely to the web direction of the starting paper web, wherein the preforming station and the at least one embossing device are matched with one another such that the rolled-up winding sections push against one another transversely to the web direction in an infeed region of the embossing device.

30. (canceled)

31. The cushioning material forming apparatus according to claim 28, wherein the at least one embossing device comprises two embossing rollers adapted to mesh into one another, the two embossing rollers including a plurality of axial segments, wherein at least one of the embossing rollers comprises:
at least one punching segment arranged in the axial direction adjacent to at least one of the embossing segments and adapted to introduce one or more punching perforations into the embossing region;
a punching segment arranged in the axial direction between two embossing segments and adapted to introduce one or more punching perforations into the embossing region; and/or
the two embossing rollers have outer axial segments in the axial direction, the outer axial segments including a transition from an axial front face to a circumferential face.

32. (canceled)

33. The cushioning material forming apparatus according to claim 28, further comprising:
a receptacle adapted to hold a starting material supply of the starting paper web; and/or
a take-off device adapted to communicate a conveying speed to the starting paper web arranged in a starting material supply, the take-off device being arranged upstream of the embossing device in a conveying direction and matched to the embossing device to provide tension relief of the starting paper web in the region of the embossing device and/or in an infeed region.

34. (canceled)

35. The cushioning Cushioning-material forming apparatus according to claim 28, further comprising:
a separator arranged immediately downstream of the embossing device in a conveying direction and adapted to separate cushioning pieces from a cushioning strand; and
a removing device arranged immediately downstream of the separator separating and adapted to grip the separated cushioning pieces.
